(19) United States
(12) Patent Application Publication
(10) Pub. No.: US 2021/0197114 A1
(43) Pub. Date: Jul. 1, 2021

(54) Air Preparation Device of a Vehicle

(71) Applicant: Knorr-Bremse Systeme fuer Nutzfahrzeuge GmbH, Muenchen (DE)

(72) Inventors: Max MICHALSKI, Neubiberg (DE); Karsten SCHNITTGER, Muenchen (DE)

(21) Appl. No.: 17/058,010

(22) PCT Filed: Apr. 30, 2019
(86) PCT No.: PCT/EP2019/061091

§ 371 Date: Nov. 23, 2020

(30) Foreign Application Priority Data
May 24, 2018 (DE) 10 2018 112 521.6

(51) Int. Cl. B01D 53/04; F04D 27/00; B60T 17/00; B60T 17/02; B60T 17/22; F15B 21/048; B01D 53/26

(52) U.S. Cl. CPC B01D 53/0446; F04D 27/009; B60T 17/004; B60T 17/02; B60T 17/221; B01D 2259/40086; B01D 53/261; B01D 53/0454; B60G 2600/66; B01D 2257/80; B01D 2259/4566; F15B 21/048

(57) ABSTRACT

An air preparation device having an electronic control unit for supplying at least one load circuit of a vehicle with dried system air, includes an air dryer unit for drying compressed air produced by an pneumatically switchable compressor. The air dryer unit supplies the at least one load circuit with dried compressed air via at least one overflow valve. An electromagnetic regeneration valve is provided which is connected to the control unit and returns dried compressed air along a regeneration path through the air dryer unit in order to regenerate the air dryer unit. An electromagnetic compressor control valve is provided which is connected to the control unit, for switching the pneumatically switchable compressor on and off via a pneumatic switching port, on the basis of a system pressure measurement value determined by at least one pressure sensor and supplied to the electronic control unit as an input signal. For redundant pneumatic compressor activation, a pneumatically pilot-controlled further compressor control valve is provided, to which the system pressure or a pressure proportional thereto is applied at a control inlet in order to switch on the compressor by activation of the pneumatic switching port after the system pressure has dropped below a lower limit value.

### BACKGROUND AND SUMMARY OF THE INVENTION

The present invention relates to an air preparation device having an electronic control unit for supplying at least one load circuit of a vehicle, preferably a utility vehicle, with dried system air, comprising an air dryer unit for drying compressed air produced by a pneumatically switchable compressor, which air dryer unit supplies the at least one load circuit with dried compressed air via at least one overflow valve. An electromagnetic regeneration valve is provided which is connected to the control unit and returns dried compressed air along a regeneration path through the air dryer unit in order to regenerate the air dryer unit. An electromagnetic compressor control valve is provided which is likewise connected to the control unit for switching the pneumatically switchable compressor on and off via a pneumatic switching port on the basis of a system pressure measurement value determined by at least one pressure sensor and supplied to the electronic control unit as an input signal. The invention also relates to a utility vehicle having at least one pneumatic load circuit, for example a service brake circuit, to which compressed air is supplied via such an air preparation device.

The area of use of the invention primarily extends to utility vehicles, which usually have multiple pneumatic load circuits, in order to operate a pneumatically operated brake system—preferably comprising a service and parking brake—and an air spring system for the vehicle suspension and the like. For the compressed air supply of the load circuits, dry compressed air has to be provided, which is generated by means of a compressor and then dried with an air preparation device of the type of interest here, before the dried compressed air is provided in storage containers for further use. Modern electronic air preparation devices—so-called EACs—have an electronic control unit which processes pressure measurement signals from integrated sensors, in particular also for measuring the system pressure generated, in order in this way to perform activation of electromagnetic multi-way valves which, depending on various operating modes, control the compressed air path for a delivery phase and also the compressed air path for a regeneration phase within the air preparation device. The compressed air delivered by the compressor and containing oil and water is filtered and cleaned by the EAC.

In the delivery phase, the compressed air generated by the compressor is dried via an air dryer unit and then provided to the various load circuits via overflow valves, for example in the form of a multi-circuit protection valve.

In the regeneration phase, some of the dried compressed air flows via a regeneration path of the air preparation device back through the air dryer unit, in order to extract the moisture from the drying granules contain therein, so that the air dryer unit is regenerated again for a subsequent delivery phase.

DE 10 2011 011 628 A1 discloses an air preparation device of the generic type, which feeds compressed air at the necessary pressure level and in the correct filling order to various load circuits of a utility vehicle. To this end, the electronic air preparation device switches a pneumatically switchable compressor on or off as a function of the system pressure. The system pressure is measured via an electric pressure sensor. If an upper threshold value for the system pressure—called the switch-off pressure—is reached, then the compressor is switched off pneumatically via a compressor control port of the air preparation device, by compressed air being applied to the compressor control port. If, following a consumption of air, a lower threshold value for the system pressure—called the switch-on pressure—is reached, then the compressor is switched on by the compressor control port of the air preparation device being vented. In the following delivery phase, the system pressure rises again until the switch-off pressure is reached. If necessary or at fixed time intervals, some of the compressed area generated and dried is used within the context of a regeneration phase described previously to dehumidify the air dryer unit. To switch the compressor on and off and to initiate a regeneration phase, within the context of the air preparation device, associated electromagnetic multi-way valves are provided, which are operated by an electronic control unit having recourse to the sensor signals. In the event of a defect, the individual load circuits are secured from one another by the electronic air preparation device, so that an adequate auxiliary braking action is available to brake the utility vehicle. As is usual, in this prior art the electric activation of the pneumatic control of the multi-way valves also dominates. Thus, the solution includes the fact that in the electric backup there is still a complete function of the air preparation available. However, this does not come into effect where the electronic control does not switch off, that is to say goes into the backup mode, because of faulty sensor values in the valid range.

Therefore, a modified safety analysis for electronic and electromechanical devices is expedient. In conventional electronic air preparation devices the real system pressure can drop so sharply, for example because of a leak, that an auxiliary braking action for the utility vehicle can no longer be ensured under all circumstances. In a specific fault scenario, the case can occur in which electric pressure sensors indicate a false excessively high measured value which lies between the switch-on pressure and the switch-off pressure. However, since the measured value lies above the switch-on pressure, the compressor is not activated. The system pressure can drop to a level at which the auxiliary braking action for the utility vehicle can no longer be ensured. This sensor malfunction also has the result that no warning can be output to the driver of the utility vehicle about this potentially dangerous situation.

The object of the present invention is, therefore, to further improve an electronic air preparation device of the generic type to the effect that, despite a sensor malfunction, the auxiliary braking action for the vehicle is not impaired.

The invention includes the technical teaching that an electronic air preparation device according to the basic principle comprises a redundant pneumatic compressor activation, in which a pneumatically pilot-controlled further compressor control valve is provided to which the system pressure or a pressure proportional thereto is applied at a control input in order to switch on the compressor by activating the pneumatic switching port after the system pressure has dropped below a lower-defined lower limiting value.

This switching-on by means of the further compressor control valve is in this case performed redundantly with respect to the switching-on by means of the electromagnetic compressor control valve activated by the electronic control unit.

The advantage of the solution according to the invention lies in particular in the fact that, by virtue of the redundant pneumatic compressor activation, the compressor is switched on also when there is a sensor malfunction which leads to the electronic control unit no longer being able to detect a sub-critical system pressure state. Refilling of the system pressure is guaranteed by the pneumatic redundancy, so that the auxiliary braking action for the utility vehicle is maintained in the fault highlighted here.

According to a preferred embodiment of the invention, it is proposed that, in the implementation of an inverse circuit, the compressor is switched on when its pneumatic switching port is vented, and the compressor switches off when pressure is applied to its pneumatic switching port. For this purpose, the further compressor control valve is preferably designed as a pneumatically pilot-controlled 2/2-way valve of NO design (NO=normally open), which is in the blocking position as long as the system pressure has not reached a lower threshold value. The setting of the threshold value is carried out via an adjustment of the spring force which counteracts the pneumatic control pressure, and is sufficiently well known in the monostable multi-way valves of interest here.

Within the context of the preferred embodiment, it is proposed that the further compressor control valve for switching the compressor on connects the pneumatic control port for the compressor to a bleed port on the air preparation device. In this way, the switching pressure for the compressor drops to the atmospheric pressure level, which leads to the compressor being switched on to increase the system pressure. Conversely, provision is made for the further compressor control valve for switching the compressor off to preferably block the pneumatic switching port for the compressor with respect to the bleed port. In this way, the rising system pressure acts on the switching port for the compressor until the pressure level of the latter permits the compressor to be switched off

Within the context of the normal operation of the electronic air preparation device, which is carried out via the electronic control unit, above the upper threshold value of the system pressure, the connection to the bleed is also blocked by the electropneumatic multi-way valve for the compressor control. According to the control strategy of the electronic air preparation device, the compressor can be switched on or off electronically by actuating the appropriate electromagnetic multi-way valves when the switch-on pressure is undershot or the switch-off pressure is reached.

In the event of a fault with a sharply dropping system pressure but correctly operating electric pressure sensors, a pressure loss is detected and the electronic control unit switches the compressor on via the associated electromagnetic multi-way valve. In addition, the driver of the utility vehicle receives a warning message about the excessively low brake pressure. In the fault scenario presented above with falsely measuring pressure sensors, however, the system pressure drops unnoticed below the lower threshold value at which the electronic control unit would actually have to trigger the switching-on of the compressor. In pneumatic redundancy, instead, the pneumatically pilot-controlled further compressor control valve switches back into its basic position, however. In this way, the pneumatic control port of the compressor is vented, so that the compressor is nevertheless switched on and as a result increases the system pressure again.

In order to avoid switching competition of the electronic control unit with respect to the redundant pneumatic control, according to a measure that improves the invention, the switching pressure of the further compressor control valve lies below the switching pressure controlled electrically via the electronic control unit for switching on the compressor via the electromagnetic compressor control valve, so that the electronic control is automatically given priority over the redundant pneumatic control.

Besides the activation of the pneumatically switchable compressor, the air preparation device of the type of interest here also effects regeneration of the air dryer unit. Within this context it is proposed that the regeneration valve is designed as an electromagnetic multi-way valve which is controlled in accordance with the electronic control unit in order to change the air preparation unit over from a delivery operation to a regeneration operation. Preferably, a bleed valve arranged in the regeneration path connects a connecting line on the input side of the compressor to a bleed port if the air preparation device is in regeneration operation, wherein the bleed valve is pilot-controlled pneumatically via a connection to the pneumatic switching port of the compressor. As an alternative to this, a bleed valve arranged in the regeneration path can also connect a connecting line on the input side of the compressor to a bleed port if the air preparation device is in regeneration operation, wherein the bleed valve is pilot-controlled pneumatically via a connection on the working-port side to the electromagnetic regeneration valve. This second design variant is distinguished as more energy-saving as compared with the first design variant.

Further measures improving the invention will be illustrated in more detail below by using the figures together with the description of a preferred exemplary embodiment.

### BRIEF DESCRIPTION OF THE DRAWINGS

FIG. 1 shows a pneumatic switching diagram for an electronic air preparation device in a first embodiment, and

FIG. 2 shows a pneumatic switching diagram for an electronic air preparation device in a second embodiment.

### DETAILED DESCRIPTION OF THE DRAWINGS

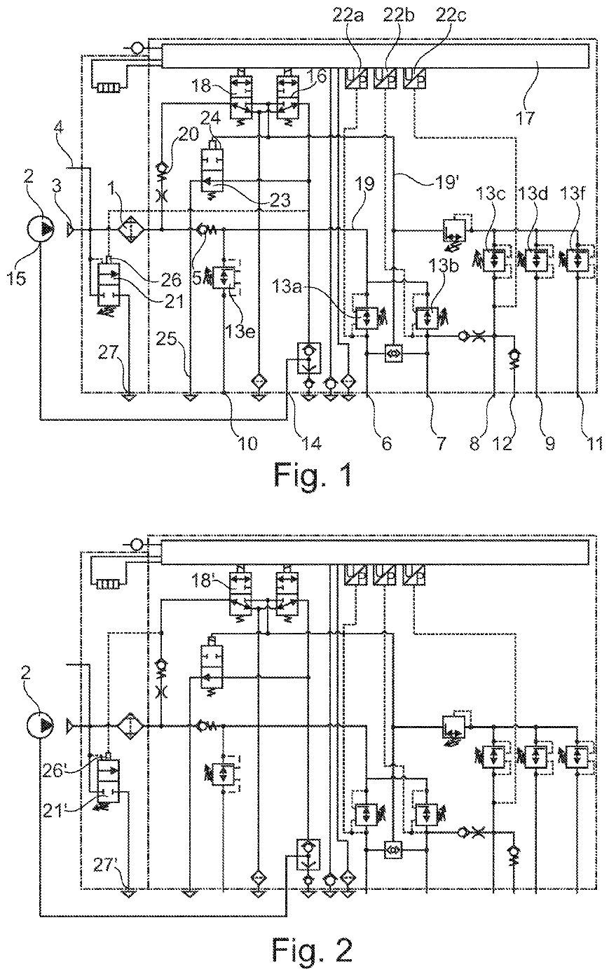

According to FIG. 1, an electronic air preparation device comprises an air dryer unit 1 for drying compressed air generated by a pneumatically switchable compressor 2. The compressed air generated by the compressor 2 is fed to the input side of the electronic air preparation device via a compressor port 3. In addition, there exists a parallel external filling port 4 which, in the event of maintenance, can have compressed air generated in stationary manner applied, so that in this case the compressor 2 does not have to be operated.

The compressed air dried by the air dryer unit 1 is supplied via a check valve 5 to multiple load circuits as system pressure. In this exemplary embodiment, a service brake for the front axle of a utility vehicle, which can be connected via the load circuit port 6, a service brake for the rear axle of a utility vehicle, which can be connected via a load circuit port 7, a service brake for a trailer of the utility vehicle, which can be connected via a load circuit port 8, and a transmission port 9, an air spring port 10, a pneumatic auxiliary device port 11 and a parking brake port 12 count as load circuits.

The aforementioned ports for load circuits are secured via various respectively associated overflow valves 13a to 13f.

Besides the previously described ports for the load circuits, the electronic air preparation device also has a pneumatic switching port 14 for switching the compressor 2 on and off via its pneumatic switching input 15. The pneumatic switching port 14 is activated via an electromagnetic compressor control valve 16, which is activated by an electronic control unit 17 to switch the compressor 2 on and off. In addition, the electronic control unit 17 also serves to activate an electromagnetic regeneration valve 18 connected thereto, which returns dried compressed air along a regeneration path through the air dryer unit 1 to regenerate the air dryer unit 1.

To generate dried compressed air along a delivery path, the compressed air generated by the compressor 2 reaches the air dryer unit 1 via the compressor port 3. The air dryer unit 1 contains a drying agent, which extracts the moisture from the compressed air and introduces the dried compressed air via the check valve 5 into a system pressure line 19, from which the various load circuits are supplied with dried compressed air. Some of the load circuits are in this case pressurized via a high-pressure changeover valve.

If the compressor 2 is switched off via the pneumatic switching port 14 after reaching an upper pressure threshold value, then, in accordance with the electronic control unit 17, regeneration of the drying agent located in the air dryer unit 1 can be carried out. For this purpose, the regeneration valve 18 is activated, which is fed with dried compressed air from the pressure line 19′ carrying system pressure and, in the switched state, leads said dried air through the air dryer unit 1 counter to the conveying direction via a check valve 20, in order to dehumidify the drying agent again. The compressed air emerging from the dryer unit 1 along the further regeneration path is then led away to the atmosphere via a switched-over bleed valve 21 and a bleed port 27.

The compressor control valve 16 is assigned multiple pressure sensors 22a-22c, wherein the electronic control unit 17 measures the system pressure value respectively present after the overflow valves 13a, 13b and 13c and, in the delivery phase, when an upper threshold value is reached, activates the compressor control valve 16 to switch off the compressor 2 via the pneumatic switching port 14. For this purpose, the pneumatic switching port 14 in the changed-over position of the compressor control valve 16 has the system pressure taken from the pressure line 19′ applied thereto. To switch off the compressor 2, the pneumatic switching port 14 is vented.

A pneumatic compressor activation that is redundant relative to this electronic compressor activation also operates a pneumatically pilot-controlled compressor control valve 23. A control input 24 of the compressor control valve 23 is connected to the pressure line 19′ carrying system pressure so that, after the system pressure has dropped below a lower limiting value, the compressor 2 can be switched on by activating the pneumatic switching port 14. For this purpose, the compressor control valve 23 in the switching position illustrated connects the pneumatic switching port 14 for the compressor 2 to the atmosphere, therefore vents the same.

In this exemplary embodiment, the compressor control valve 23 is designed as a pneumatically pilot-controlled 2/2-way valve of NO design and is in the blocking position as long as the system pressure does not reach a lower threshold value. In this way, switching on the compressor 2 when there is still adequate system pressure is avoided. The switching pressure of the compressor control valve 23 lies below the switching pressure of the electromagnetic compressor control valve 16 controlled electrically via the control unit 17, so that the electronic control is automatically given priority over the redundant pneumatic control. Thus, the redundant pneumatic control functions only as a type of emergency switching-on of the compressor 2 if the sensors possibly fail according to the fault scenario outlined at the beginning.

The aforementioned bleed valve 21 arranged in the regeneration path of the air preparation device is activated via its control input 26 by a connection to the pneumatic switching port 14 of the compressor 2 by the pressure present here. If pressure is present on the pneumatic switching port 14 in order to switch off the compressor 2, then the bleed valve 21 is changed to the open switching position so that, in the regeneration phase, the moisture-laden compressed air leaving the air dryer unit 1 is led away to the atmosphere via a bleed port 27.

FIG. 2 illustrates an energy-saving pneumatic switching arrangement as distinct from the above-described exemplary embodiment, which, apart from the arrangement and wiring of the bleed valve 21′ arranged in the regeneration path, is identical to the previously described exemplary embodiment, to which complete reference is made to this extent.

The bleed valve 21′ here also connects a connecting line on the input side of the compressor 2 to the bleed port 27′ if the air preparation device is in regeneration operation. The control port 26′ of the bleed valve 21′ is, however, connected on the working-port side to the electromagnetic regeneration valve 18. Therefore, the bleed valve 21′ is actuated only when the regeneration phase has been initiated, so that compressed air is saved as opposed to the above switching variant.

The solution according to the invention is not restricted to an application in the two exemplary embodiments described above. Instead, modifications thereof which are also covered by the scope of protection of the following claims are also conceivable. Thus, for example, it is also possible that only a single load circuit of a vehicle or load circuits other than those described can be supplied with dried compressed air by the air preparation device according to the invention.

### LIST OF DESIGNATIONS

1 Air dryer unit
2 Compressor
3 Compressor port
4 External filling port
5 Check valve
6 Service brake port (front axle)
7 Service brake port (rear axle)
8 Service brake port—trailer
9 Transmission port
10 Air spring port
11 Auxiliary port
12 Parking brake port
13 Overflow valve
14 Switching port for compressor
15 Compressor control port
16 Compressor control valve
17 Electronic control unit
18 Regeneration valve
19 Pressure line carrying system pressure
20 Check valve
21 Bleed valve
22 Pressure sensor
23 Further compressor control valve
24 Control input
25 Bleed port
26 Control input
27 Bleed port

1-11. (canceled)

12. An air preparation device for supplying at least one load circuit of a vehicle with dried system air, comprising:
an electronic control unit;
an air dryer unit for drying compressed air generated by a pneumatically switchable compressor, which air dryer unit supplies the at least one load circuit with dried compressed air;
a compressor control valve which is connected to the control unit and activated electrically for switching the pneumatically switchable compressor on and off via a pneumatic switching port on the basis of a system pressure measurement value determined by at least one pressure sensor and supplied to the electronic control unit as an input signal; and
a pneumatically pilot-controlled further compressor control valve for redundant pneumatic compressor activation, to which the system pressure or a pressure proportional thereto is applied at a control input in order to switch on the compressor by activation of the pneumatic switching port after the system pressure has dropped below a lower limiting value.

13. The air preparation device as claimed in claim 12, wherein
in an implementation of an inverse circuit, the compressor is switched on when its pneumatic switching port is vented, and
the compressor is switched off when pressure is applied to its pneumatic switching port.

14. The air preparation device as claimed in claim 12, wherein
the further compressor control valve is a pneumatically pilot-controlled 2/2-way valve of NO design, which is in a blocking position as long as the system pressure has not reached a lower threshold value.

15. The air preparation device as claimed in claim 12, wherein
the further compressor control valve for switching the compressor on connects the pneumatic switching port for the compressor to a bleed port.

16. The air preparation device as claimed claim 15, wherein
the further compressor control valve for switching the compressor off blocks the pneumatic switching port for the compressor with respect to the bleed port.

17. The air preparation device as claimed in claim 12, wherein
the switching pressure of the further compressor control valve lies below the switching pressure controlled electrically via the control unit for switching on the compressor via the electromagnetic compressor control valve, so that the electronic control is automatically given priority over the redundant pneumatic control.

18. The air preparation device as claimed in claim 12, further comprising:
an electromagnetic regeneration valve which is connected to the control unit and returns dried compressed air along a regeneration path through the air dryer unit in order to regenerate the air dryer unit.

19. The air preparation device as claimed in claim 18, wherein
the regeneration valve is an electromagnetic multi-way valve which is controlled in accordance with the control unit in order to change the air preparation unit over from a delivery operation to a regeneration operation.

20. The air preparation device as claimed in claim 19, further comprising:
a bleed valve arranged in the regeneration path that connects a connecting line on the input side of the compressor to a bleed port if the air preparation device is in regeneration operation, wherein
the bleed valve is pilot-controlled pneumatically via a connection to the pneumatic switching port of the compressor.

21. The air preparation device as claimed in claim 19, further comprising:
a bleed valve arranged in the regeneration path that connects a connecting line on the input side of the compressor to a vent port if the air preparation device is in regeneration operation, wherein
the bleed valve is pilot-controlled pneumatically via a connection on a working-port side to the electromagnetic regeneration valve.

22. A utility vehicle, comprising:
an air preparation device as claimed in claim 12; and
at least one pneumatic load circuit, to which compressed air is supplied via the air preparation device.
